(19) United States
(12) Patent Application Publication
(10) Pub. No.: US 2023/0074083 A1
(43) Pub. Date: Mar. 9, 2023

(54) ABSORPTION TOWER FOR A NITRIC ACID PLANT METHOD FOR PRODUCING NITRIC ACID

(71) Applicants: thyssenkrupp Industrial Solutions AG, Essen (DE); thyssenkrupp AG, Essen (DE)

(72) Inventor: Bjoern STEGT, Luedinghausen (DE)

(73) Assignees: thyssenkrupp Industrial Solutions AG, Essen (DE); thyssenkrupp AG, Essen (DE)

(21) Appl. No.: 17/796,758

(22) PCT Filed: Jan. 13, 2021
(86) PCT No.: PCT/EP2021/050595

§ 371 Date: Aug. 1, 2022

(30) Foreign Application Priority Data
Feb. 3, 2020 (DE) 10 2020 201 245.8

(51) Int. Cl. C01B 21/40; B01J 10/00; B01J 19/32; B01D 53/18

(52) U.S. Cl. CPC C01B 21/40; B01J 10/00; B01J 19/32; B01D 53/185; B01J 2219/32286; B01D 2252/103

(57) ABSTRACT

An absorption tower for production of nitric acid by the Ostwald process may include sieve trays that are arranged on top of one another and each spaced apart from one another, a water inlet in an upper region of the absorption tower, an inlet for gaseous nitrogen oxides in a lower region of the absorption tower, and a column bottom that is disposed in the lower region of the absorption tower beneath a lowermost sieve tray and is divided by a dividing wall into a first, radially inner region and at least a second, radially outer region. Nitric acid that trickles down from the lowermost sieve tray with a higher concentration can be collected in a middle region. The less-concentrated nitric acid that then effluxes from sieve trays higher up can then be collected separately in a region farther outward.

The present invention relates to an absorption tower for a plant for production of nitric acid by the Ostwald method, comprising a multitude of sieve trays arranged one on top of another and each spaced apart from one another, an inlet for water in an upper region of the absorption tower, an inlet for gaseous nitrogen oxides in a lower region of the absorption tower, and a column bottom which is disposed in the lower end region of the absorption tower beneath the lowermost sieve tray and is divided by at least one dividing wall into at least two mutually separated regions.

### STATE OF THE ART

The production of nitric acid is one of the established processes in the chemical industry, which, after introduction of the Haber-Bosch process for NH₃ synthesis by W. Ostwald based on platinum catalysts, has been developed to industrial maturity, and the concept of which still nowadays forms the basis of modern HNO₃ production.

For production of nitric acid, ammonia NH₃ is first reacted with air, and nitrogen oxide NO is produced, which is then oxidized to nitrogen dioxide NO₂.

Subsequently, the nitrogen dioxide NO₂ thus obtained is absorbed in water, forming nitric acid. For absorbing a maximum amount of the nitrogen dioxide NO₂ obtained by water, the absorption is generally effected at elevated pressure, preferably at pressures between about 4 and about 14 bar.

In nitric acid production, ammonia is thus combusted with air in the presence of platinum meshes. This involves passing a gas mixture of typically about 9-12% by volume of NH₃ and air through the meshes, with establishment of a temperature of about 800-950° C. at the meshes as a result of the exothermicity of the oxidation reaction. NH₃ is oxidized very selectively here to nitrogen monoxide (NO) (A, reaction scheme I), and this is then oxidized in the continuation of the process to nitrogen dioxide (NO₂) (B, reaction scheme II) and finally reacted with water in an absorption apparatus to give HNO₃ (C, reaction scheme III).

A) Combustion of ammonia in an oxidation reactor, with reaction of ammonia with oxygen to give nitrogen oxide

4NH₃+5O₂→4NO+6H₂O (I)

B) Oxidation of nitrogen monoxide to nitrogen dioxide

2NO+O₂→2NO₂ (II)

The reaction proceeds as an uncatalyzed gas phase reaction in the nitric acid process by the Ostwald method.

C) Formation of HNO₃ (nitric acid) by absorption of NO₂ in water in the condensers and the absorption tower to reform NO

3NO₂+H₂O→2HNO₃+NO (III)

A typical process and a plant for production of nitric acid are described, for example, in WO 2018/137996 A1.

An absorption tower of a nitric acid plant in a conventional design with a number of trays spaced apart and arranged one on top of another is disclosed, for example, in U.S. Pat. No. 1,840,063 A. The water is introduced into the absorption tower in the upper region, while the nitrogen dioxide to be absorbed is supplied in the lower region of the absorption tower and can flow upward through respective orifices in the trays. The trays of the absorption tower are sieve trays, which are usually largely fully perforated. The water flows onto the uppermost tray, flows over a wall directed upward, and then passes into a vertically aligned pipe through which the liquid flows downward onto the next tray down. Each of the horizontal trays is equipped with a similar overflow apparatus and, the further the liquid progresses downward, the more concentrated the nitric acid becomes, until eventually the highest acid concentration is present in the bottom of the absorption tower. When generally at least fifteen trays one on top of another are used, it is possible to produce concentrated nitric acid with concentrations of more than 55%.

DE 23 20 520 A discloses a tray column for production of nitric acid by oxidation and absorption of nitrous gases in water, in which relatively small central perforated scrubbing trays and, spaced apart therefrom, larger, radially outer annular scrubbing trays are provided in alternation, such that the ascending nitrous gases flow without further guiding means alternately in a spiral manner from the middle of the column to the column wall and vice versa. There are also cover trays present which have an opposite conical inclination. The acid flows across the inclined cover trays from the outside to the middle to the central scrubbing trays, and from the middle to the outside to the outer annular scrubbing trays. Additionally provided are distributor channels, the overflow heights of which are such that an acid backup forms on the corresponding scrubbing trays, this being sufficient to prevent them from running dry.

US patent specification U.S. Pat. No. 3,338,567 A describes an absorption tower for the production of nitric acid, having horizontal sieve trays one on top of another, wherein gaseous nitrogen dioxide flows from the bottom upward through the perforated sieve trays and comes into contact with the liquid standing on each of the sieve trays (i.e. dilute or more or less concentrated nitric acid, according to the height of the respective sieve tray in the absorption tower). In order to prevent the liquid standing on the sieve trays from running downward through the perforations in the event of declining gas pressure of the ascending gas and hence mixing with the more highly concentrated acids on the sieve trays beneath, a liquid reservoir vessel is provided for each sieve tray, which is designed such that liquid remains standing on the sieve tray, even when the plant is being started up again after being shut down. The liquid reservoir vessel is constructed such that, if the plant is shut down, the liquid level above the sieve tray can fall within a comparatively short period. The perforated region of the tray is bounded on each side by a vertical dividing wall that ends in each case at a certain distance above the sieve tray, such that liquid can flow beneath the dividing wall into the liquid reservoir vessel. By opening a passage to the atmosphere that can be shut off by means of a valve, liquid can be discharged from the sieve tray into the liquid reservoir vessel, and hence the height of the liquid level above the sieve tray can be reduced. Conversely, when the valve of a high-pressure conduit is opened, the liquid reservoir vessel can be pressurized, and the liquid from the liquid reservoir vessel is then forced back onto the sieve tray, such that the liquid level rises there again. The vertical dividing walls used in this known absorption tower are each above the sieve trays of the absorption tower and also, in top view, run in the manner of segments with respect to the cylindrical outer wall of the absorption tower.

U.S. Pat. No. 9,849,419 B2 describes a process for producing sulfuric acid, in which liquid acid of a first concentration is fed into a gas purification system in the form of a packed absorption bed, and gas is conveyed through the gas purification system, such that a second concentration of the liquid acid is attained, with the liquid acid being drawn off from the bottom. The bottom of the absorption apparatus is divided here by a dividing wall into a first region and a second region, with acids having different concentrations being produced in the two regions. This document relates to sulfuric acid production, which differs in multiple aspects from the production of concentrated nitric acid. In sulfuric acid production, acid is introduced into the absorption tower at the top, rather than water, and the absorption tower is filled with a packed bed, through which the acid introduced at the top trickles downward. In the first region divided by the dividing wall in the bottom, water or dilute acid is added in order to dilute the acid concentration in this region of the bottom. In this process, the simultaneous production of sulfuric acid with two different acid concentrations is enabled, with a concentrated acid already being fed in at the top of the absorption tower, and the acid partly being rediluted again in the bottom of the absorption tower for adjustment of the acid concentration. The technology of sulfuric acid production is not applicable to the production of nitric acid.

For the production of nitric acid having elevated concentration (typically in the range from 60% to 65% by weight), the process gas is introduced into an absorption tower. The absorption tower is a tray column having, for example, about 25 to about 35 sieve trays. The gas enters at the foot of the column, while water is introduced at the top of the column. The process gas rises upward through the holes in the sieve trays and is absorbed in countercurrent by the liquid on the sieve trays. The pressure of the ascending gas prevents the liquid from “trickling down” through the holes, i.e. emptying of the absorber trays is thus suppressed.

On each tray, a concentration equilibrium results between the acid concentration of the liquid and the nitrogen oxide content in the gas phase. Viewed over all trays, a concentration profile is thus established, in which the acid concentration is at its highest at the foot of the absorption column, while only a very small concentration is present at the top of the column.

In the case of a pressure drop on the part of the gas supplied (for example in the case of a plant shutdown or a fault), the backpressure of the gas is no longer sufficient to keep the liquid on the tray, and so it “trickles down” and is collected in the bottom of the column. First of all, the lower trays with the higher acid concentration trickle down, followed by ever further-diluted acid from the upper portion of the absorption tower. The nitric acid that has trickled down in the bottom of the column thus constitutes a mixture from all trays (a comparatively strong acid present at the bottom, a comparatively weak acid formed at the top). The total concentration of the mixture is thus relatively low.

For the startup of the plant, a certain amount of nitric acid is normally introduced onto the lower trays in the absorption tower. As a result, the concentration profile is established much more quickly than if water were to be used for the startup. The higher the acid concentration on the lowermost tray, the better the manner in which this is accomplished. Thus, if the above-described overall mixture were to be used as the initial charge, the concentration would be smaller than what has trickled down from the lowermost tray beforehand.

The prior art additionally discloses the use of an external buffer tank. This is supplied with the acid that has trickled down, and a relatively dilute acid mixture is established with just one concentration. As well as this disadvantage, it should be noted that, for this approach, a further tank, construction space, additional piping, etc. are needed, which is reflected in the costs of the plant.

The establishment of a concentration profile in the absorption tower with just one bottom took too long in conventional absorption towers. Furthermore, at first only acid of relatively low concentration was produced in the initial phase in conventional absorption towers.

It is an object of the present invention to provide an absorption tower for a plant for production of nitric acid having the features specified at the outset, which enables the production of an amount of acid with a particular average concentration, especially for the filling of the column trays before plant startup, in order to enable improved absorption—compared to water or a reduced acid concentration compared to said acid concentration.

The aforementioned object is achieved by an absorption tower for a plant for production of nitric acid of the type specified at the outset having the features of claim 1.

According to the invention, at least one dividing wall disposed in the column bottom of the absorption tower has such a progression that it divides the column bottom into a first, radially inner region and at least a second, radially outer region. This division makes it possible to collect a nitric acid having a higher concentration in the first, radially inner region. When this region is filled with a comparatively concentrated nitric acid as the nitric acid trickles down from the lower separating trays, it is possible for further nitric acid flowing in, which trickles down from the higher sieve trays and is consequently less concentrated, to flow over into the further, radially outer region, such that a less concentrated acid is collected there, and the less concentrated nitric acid flowing in is prevented from diluting the nitric acid in the radially inner region of the column bottom.

Some terms used herein are to be elucidated once again hereinafter for better understanding of the present description of the invention.

The expression “nitrogen oxides” is used as an umbrella term in industry for the oxides of the various oxidation states that are formed in the oxidation reaction of ammonia, namely nitrogen monoxide (NO), nitrogen dioxide (NO₂), dinitrogen tetroxide (N₂O₄) and dinitrogen monoxide (N₂O), although the reaction forms mainly NO and NO₂. These different nitrogen oxides are also referred to collectively as NOx. In the step of absorption of the nitrogen oxides in water, which proceeds in the absorption tower of the invention, according to the above equation C), nitrogen dioxide (NO₂), in which the nitrogen has the oxidation state 4, is oxidized further to nitric acid (HNO₃), in which nitrogen is in the oxidation state 5.

This reaction of absorption of nitrogen dioxide in water proceeds in an absorption tower, which is an absorption column here, having multiple sieve trays and a column bottom in its lower region. The terms “absorption tower” and “absorption column” may be considered to be synonymous in the context of the present invention.

A “sieve tray” in an absorption tower is a structure essentially in plate form, which is disposed in the absorption tower usually horizontally or, where appropriate, inclined relative to horizontal, and which has numerous holes or perforations, such that, firstly, the liquid of the nitric acid that forms can run away through the holes of a sieve tray down to a sieve tray beneath if the gas pressure below the sieve tray declines (this is also referred to as “trickling”), and, secondly, the gaseous nitrogen dioxide can ascend from the bottom upward and flow through the holes in the sieve tray, such that the gaseous phase comes into contact with the liquid phase, and nitric acid is formed by the absorption process.

The term “dividing wall” used here is understood to mean an essentially vertical structure made of a material having sufficient acid resistance, which is disposed in the bottom of the absorption tower and divides a first region of the column bottom from at least a second region of the column bottom in such a way that liquid cannot flow directly horizontally from the one region into the other region. This means that the dividing wall extends downward as far as the base of the bottom, such that, unlike, for example, in the case of the walls above the sieve trays according to U.S. Pat. No. 3,338,567 A, it is also impossible for any liquid to flow beneath the dividing wall. In addition, the dividing wall also does not have any openings up to its upper boundary, such that liquid can get from the first region into the second region only by flowing over the dividing wall.

In a preferred development of the plant of the invention, the at least one dividing wall is cylindrical at least in sections. This means that a first, preferably cylindrical, region or one that is cylindrical at least partly or in sections arises within the dividing wall, which is divided from at least one second region radially further to the outside which is bounded on the inside by the cylindrical dividing wall and which surrounds the first inner region.

In a preferred development of the plant of the invention, the at least one dividing wall is disposed in the column bottom in a concentric arrangement with a radial distance from the outer wall and divides the column bottom into a first cylindrical central region within the dividing wall and a second annular radially outer region outside the dividing wall. This second annular, radially outer region, in this preferred variant, thus concentrically surrounds the cylindrical inner region, such that concentrated acid trickling down from the lower sieve tray(s), for example, when the plant is shut down first arrives in the first, inner cylindrical region and can be obtained (drawn off) therefrom, in order, for example, to use this concentrated acid in the restarting of the plant. The acid that then flows in later on from the sieve trays further up is less concentrated and, once the inner region has filled, flows over the dividing wall and hence gets at least very substantially into the radially outer region beyond the dividing wall. Minor mixing of less concentrated nitric acid takes place at most in the uppermost section of the inner region, and this effect is negligible in respect of the total concentration of the acid in the first inner region. Very predominantly, the less concentrated nitric acid thus arrives in the second annular outer region, and can be obtained separately from the nitric acid in the first inner region.

In a preferred development of the plant of the invention, a first, radially inner dividing wall is disposed in the column bottom in a concentric arrangement with a radial distance from the outer wall, and a second, radially outer dividing wall is disposed in a concentric arrangement with a radial distance from the first dividing wall and between the radially inner dividing wall and the outer wall of the column bottom. In this possible variant of the invention, there are thus two mutually spaced-apart dividing walls, which results in a total of three mutually separate regions in the bottom of the absorption column, namely a first central cylindrical inner region, an annular second middle region that surrounds the inner region in annular form, and a third radially outer, likewise annular region that in turn surrounds the second middle region in annular form. In this construction variant of the plant, it is therefore possible to cover the second and third regions such that the concentrated nitric acid that initially trickles down from the lower sieve trays at first runs only into the inner annular region, then the less concentrated nitric acid gets into the second middle region via overflow, and then, when this second middle region too is filled, the less concentrated nitric acid gets into the third, radially outer region as a result of overflow of the second middle region, such that three different volumes each having differently concentrated nitric acids are obtained in the bottom of the absorption column, and can be drawn off separately from each of these regions.

In a corresponding manner, it is also possible to provide further dividing walls, which results in four or more than four mutually separate regions in which nitric acid is collected with a different concentration in each case. In the case of more than two cylindrical dividing walls, a first, radially inner dividing wall is thus disposed in a concentric arrangement in the column bottom with a radial distance from the outer wall, a second dividing wall radially further outward is disposed in a concentric arrangement with a radial distance from the first dividing wall, and a third, optionally a fourth and further dividing wall(s) is/are disposed in a concentric arrangement with respect to the second dividing wall between the second dividing wall and the outer wall of the column bottom.

In one possible alternative construction variant of the plant of the invention, at least two mutually parallel dividing walls are provided, which divide the column bottom into one rectangular, radially inner region and two segment-shaped radially outer regions. In this variant, the two mutually parallel linear dividing walls replace a continuous cylindrical dividing wall. Owing to the cylindrical geometry of the outer wall of the absorption tower, two segment-shaped radially outer regions then arise beyond the inner rectangular region, in which the less concentrated nitric acid is collected. In this construction variant, the mutually separate regions are thus not concentric with respect to one another. However, the above-described principle of function of the mutually separate regions, in which the middle region is first filled with concentrated nitric acid and then the less concentrated nitric acid overflows into the outer regions divided from the middle region, exists in this variant too.

In the aforementioned variant too, it is possible to provide further dividing walls further radially outward, preferably parallel to the dividing walls further radially inward, which divide off further regions, so as to result in a total of three, four or more mutually separate regions.

In a preferred development of the invention, in the plant of the invention, a cover is provided above a first dividing wall or, in the case of multiple dividing walls, above the radially outer dividing walls, which has an inclination at an angle to the horizontal toward the middle of the column bottom, the dimensions of this cover being such that it fully covers the shell space between the first dividing wall or the radially outer dividing walls and the outer wall of the column bottom. This measure prevents nitric acid that initially runs off the lower sieve trays from flowing into the radially outer region(s). First of all, the concentrated nitric acid thus goes into the middle region, such that concentrated nitric acid can be drawn off therefrom. The radially outer regions are directly covered from the top in respect of direct access, and only when the middle region is filled with nitric acid and further, now less concentrated nitric acid is replenished from the top can this flow over the dividing wall into a region further radially outward.

In a preferred development of the plant of the invention, therefore, at least one first conduit for nitric acid proceeds from the first radially inner region in order to draw off nitric acid therefrom, and at least one further conduit for nitric acid separate from the first conduit proceeds from at least one second, radially outer region in order to draw off nitric acid from this second region. In this way, it is possible to draw off nitric acid volumes with different concentrations each separately from the mutually separate regions.

The inventive use of additional internals in the form of the aforementioned dividing walls in the bottom of the absorption column achieves the effect that the nitric acid that has trickled down can be obtained separately. This makes it possible to make further use of the more highly concentrated nitric acid that trickles down first from the lower trays, and to apply it again to the lower sieve trays in the next startup of the plant.

The additional internals preferably consist of a cylindrical portion and a cover inclined slightly inward above the outer gap that results, which extends between the dividing wall and the outer wall of the absorption column.

The volume of the inner bottom is chosen such that the collecting of the acid from the corresponding number of trays in the inner bottom achieves the desired concentration. The volume of the outer bottom is chosen such that the residual acid on the trays is collected in the outer bottom. It is possible here, for example, to ensure an additional safety margin for repeated startup tests.

The nitric acid trickling down from the lower trays at first flows into the inner cylindrical or roughly rectangular region. Nitric acid is present here with a higher concentration (for example, with 45% by weight in the inner bottom, relative to about 2% by weight in the outer bottom). The acid concentration is fixed by the absorber profile desired.

The dimensions of the inner, preferably cylindrical or roughly rectangular region here are such that the accommodation volume can accommodate the liquid volumes of the desired trays (i.e. up to the desired concentration). Further liquid trickling down continues to arrive, but overfills the inner cylinder and runs over into the resultant outer gap. The mixing of weak overflowing nitric acid with more highly concentrated nitric acid takes place here essentially only in the uppermost region of the cylinder.

In general, the volume and the resulting division of the nitric acid concentration is individual from plant to plant. It is guided by the design of the absorption tower.

In this way, it is possible to reuse a portion of the nitric acid without additional apparatus complexity, and no nitric acid, or less concentrated nitric acid, is required for startup of the plant.

Possible embodiments that shall be covered here by the scope of protection of the present invention include all volume combinations, i.e. it shall be possible to reduce the size of the outer ring with the separation plates in the inward direction, such that the collected volume of more highly concentrated acid is reduced and there is a rise in the lower-concentrated volume. In addition, the height of the division between outer and inner chambers shall be variable. Moreover, multiple chambers shall be included, i.e. a bottom division comprising multiple concentration profiles if further dividing walls are installed. These would preferably be at lower heights than the first wall. The number of further dividing walls and their respective heights are unlimited.

The present invention further provides a plant for production of nitric acid, especially by a process of the type described above, comprising an absorption tower with the above-described features.

The present invention also provides a process for producing nitric acid by the Ostwald process, comprising a process step in which absorption of gaseous nitrogen oxides in water takes place to produce nitric acid in an absorption tower, wherein the nitrogen oxides are introduced into the absorption tower in a lower region and water is introduced into the absorption tower in an upper region, wherein the nitric acid formed flows downward through a multitude of sieve trays arranged one on top of another and each spaced apart from one another, and the nitrogen oxides flow upward from below through the absorption tower in countercurrent with the aqueous liquid, wherein in the column bottom of the absorption tower, concentrated nitric acid accumulates wherein, according to the invention, by internals in the column bottom, especially by at least one dividing wall in the column bottom, at least two mutually divided regions are created in which nitric acid of different concentration is collected, wherein by at least one cover above one of the divided regions, the effect is achieved that nitric acid that effluxes first from the sieve trays flows only into one of the divided regions.

In a preferred development of the process of the invention, concentrated nitric acid effluxing from the sieve trays is first collected in a first, central region of the column bottom, and only after this first central region has filled completely, less concentrated nitric acid passes via overflow over a preferably circular cylindrical or linear dividing wall into at least one second region which is radially further outward and is divided from the first region.

In a preferred development of the process, after filling the second region radially further outward completely, less concentrated nitric acid passes via overflow over a further, preferably circular cylindrical or linear, dividing wall into a third region which is radially even further outward and is divided from the second region.

In a preferred development of the process, the respective position of the dividing wall(s) in the column bottom and of the cover above the divided regions determines the ratio of the volumes of more highly concentrated nitric acid to less concentrated nitric acid produced.

The aforementioned process for producing nitric acid is preferably conducted a plant comprising an absorption tower having the above-described features.

The present invention is described in detail by two working examples with reference to the appended drawings. The figures show:

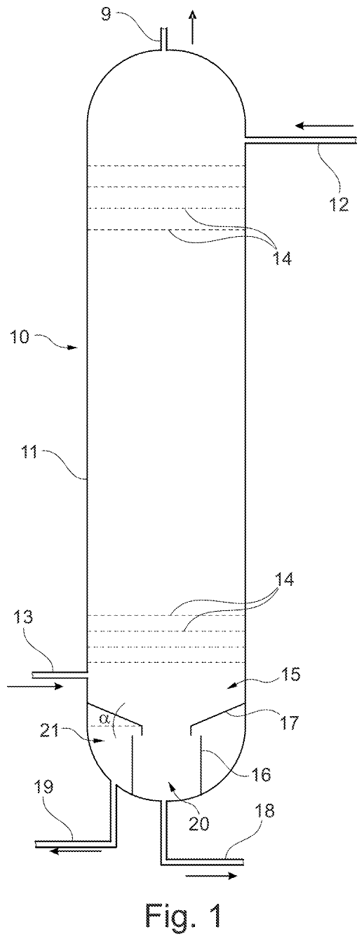

FIG. 1: a schematically simplified diagram of an absorption tower of an illustrative plant of the invention for production of nitric acid;

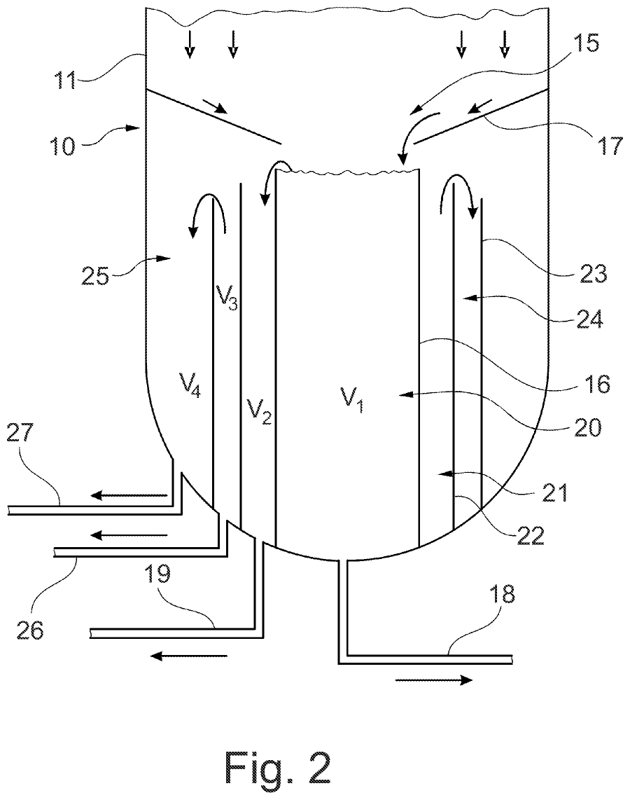

FIG. 2: a schematically simplified diagram of the lower region of an absorption tower in an alternative execution variant of an illustrative plant for production of nitric acid according to the present invention.

Reference is made hereinafter firstly to FIG. 1, and this diagram is used to elucidate a first illustrative execution variant of the invention in detail. The diagram of the absorption tower 10 in FIG. 1 is schematically highly simplified, and only those plant components that are of significance in the context of the present invention are shown. FIG. 1 shows only the absorption tower 10. The other plant components of a plant for production of nitric acid that are not shown here are known per se; the incorporation of the absorption tower into the overall plant for production of nitric acid is likewise known per se and is therefore not described in detail.

The inventive absorption tower 10 is a column having a fundamentally cylindrical geometry, wherein the column in the top region and in the region of the bottom 15 may be executed as a vessel rounded at each end. In an upper region, process water is introduced into the absorption tower 10 via a feed conduit 12 and, in a lower region, NOx gases or acid condensate are supplied to the absorption tower 10 via a feed conduit 13, such that these NOx gases flow in countercurrent to the water within the absorption tower 10, which flows from the top downward. The residual gas is removed via a conduit 9 at the top of the absorption tower 10 and is then subjected to further processing, which is not shown here in detail.

In the interior, the absorption tower has a relatively large number of, for example, twenty or more (typically 25 to 40) sieve trays 14, which are preferably each installed horizontally and arranged in parallel one on top of another and at a distance from one another. By way of simplification, FIG. 1 shows just some of these sieve trays. The incoming process water at first arrives at the uppermost sieve tray and flows proceeding therefrom successively further downward to the further sieve trays. The NOx gases ascend in the absorption tower, flow upward through the perforations in the sieve trays 14 and hence come into contact with the aqueous liquid on the sieve trays 14, in which they are absorbed, which results in formation of nitric acid. In steady-state operation, a concentration profile develops within the absorption tower 10, with increasing concentration of the nitric acid on the sieve trays from the top downward. The pressure of the NOx gases flowing from the bottom upward results in formation of a liquid column on each of the sieve trays. But if this gas pressure decreases when the plant is shut down, the effect of this is that the nitric acid trickles downward through the perforations of the sieve trays.

FIG. 1 shows a first simplified solution variant of the invention, in which a cylindrical dividing wall 16 is installed in the bottom 15 of the absorption column 10 below the lowermost sieve trays 14 in a roughly central region, and preferably runs vertically and divides a first middle, radially inner region 20 of the bottom 15 from an annular second, radially outer region 21 of the bottom. Above the dividing wall 16, spaced apart somewhat therefrom, is disposed a cover 17 in a radially outer region, which runs radially, is connected to the outer cylindrical wall 11 of the absorption tower 10, and extends radially inward therefrom to such an extent that it fully covers the second radially outer region 21 when projected onto the horizontal plane. This cover, which may take the form, for example, of a cover plate or the like made from an acid-resistant material, runs inclined at an angle α to the horizontal from radially outward to radially inward, such that nitric acid that trickles down from the sieve trays 14 above the cover 17 at first flows inward over the cover 17 and then flows exclusively into the first radially inner region 20, since the second, radially outer region 21 is covered by the cover 17. This first middle region 20 is provided with an output conduit 18, such that concentrated nitric acid that collects in the first middle region 20 can be removed separately via this first output conduit 18.

When the plant is shut down or run down, the first nitric acid to trickle down is that from the lower sieve trays 14, which is the most concentrated, such that predominantly concentrated nitric acid arrives in the middle region 20, which can be applied again to the lower sieve trays on restarting of the plant, in order thus to shorten the initial phase in which the plant produces solely dilute nitric acid. When the plant is being run down, only when such an amount of nitric acid has run down from the lower sieve trays that the first volume of the first middle region 20 is filled does the nitric acid that then continues to efflux from the sieve trays 14, the concentration of which decreases gradually, flow over the upper end of the dividing wall 16 and hence arrive in the second, radially outer region 21. This second region is likewise provided with an output conduit 19, such that the less concentrated nitric acid that collects in this second region 21 can be removed separately from the bottom 15 of the absorption tower 10 via the output conduit 19.

The nitric acid produced in the absorption tower 10, which is removed via the two output conduits 18, 19, is subsequently generally supplied in a manner known per se to a bleaching tower in which the nitric acid is purified, which is not shown here in detail.

A second alternative variant of the present invention is elucidated in detail hereinafter with reference to FIG. 2. In this further working example, only the lower region with the bottom 15 of an absorption tower 10 is shown on an enlarged scale compared to FIG. 1. By contrast with the variant of FIG. 1, in the embodiment according to FIG. 2, a total of three dividing walls 16, 22, 23 are provided, which, for example, are in the form of concentric cylindrical rings. Similarly to the variant of FIG. 1, the radially inner dividing wall 16 divides a first middle region 20 from a second region 21 radially further outward, which surrounds the first middle region 20 in the form of a ring. A further dividing wall 22 divides this second region 21 on the outside from a third region 24 even further radially outward, which in turn surrounds the second region 21 on the outside in the form of a ring. Finally, a third dividing wall 23 is provided, which is radially even further outward and divides the third region 24 from an outer fourth region 25, which surrounds the third region 24 on the outside in the form of a ring and which is bounded to the outside by the outer wall 11 of the absorption tower 10.

As soon as the first inner region 20 is filled with concentrated nitric acid, this flows over the first dividing wall 16 into the second region 21. When the latter is also filled with nitric acid, nitric acid flows over the dividing wall 22 into the third region 24, and, finally, nitric acid, when the third region 24 is also filled, flows over the dividing wall 23 into the fourth outer region 25. As apparent in the working example, the individual regions divided from one another by the dividing walls may have different volumes, which is dependent on the radial width of the respective region and on the respective distance from the center of the absorption tower. It is thus possible via the choice of the respective position of the individual dividing walls 16, 22, 23 to determine the intended size of the volumes of the differently concentrated acids in the regions. The first middle region accommodates a liquid volume V₁, the second region a liquid volume V₂, the third region a liquid volume V₃ and the fourth, radially outer region a liquid volume V₄, and the liquid volumes V₁ to V₄ may all be of different sizes.

Each of the four divided regions mentioned is preferably provided with a separate conduit 18, 19, 26, 27, via which the nitric acid can be removed. As also apparent in FIG. 2, the height of the dividing walls decreases in each case from radially inward to outward in the absorption tower, such that, with the second region 21 filled, the nitric acid overflows into the third region 24 further radially outward, and cannot flow back into the first inner region 20.

### LIST OF REFERENCE NUMERALS

9 conduit for tail gas
10 absorption tower, absorption column
11 outer cylindrical wall
12 feed conduit for process water
13 feed conduit for NOx gases
14 sieve trays
15 column bottom
16 dividing wall
17 cover
18 output conduit for concentrated nitric acid
19 output conduit for less concentrated nitric acid
20 first radially inner region
21 second radially outer region
22 middle dividing wall
23 outer dividing wall
24 third annular region
25 fourth outer annular region
26 conduit for nitric acid to be removed
27 conduit for nitric acid to be removed

1.-20. (canceled)

21. An absorption tower for a plant for production of nitric acid by the Ostwald method, the absorption tower comprising:
sieve trays disposed one on top of another and each spaced apart from one another;
an inlet for water in an upper region of the absorption tower;
an inlet for gaseous nitrogen oxides in a lower region of the absorption tower; and
a column bottom that is disposed in the lower region of the absorption tower beneath a lowermost sieve tray of the sieve trays, the column bottom being divided by a dividing wall into mutually separated regions, wherein the dividing wall is disposed with such a progression that the dividing wall divides the column bottom into a first, radially inner region and a second, radially outer region.

22. The absorption tower of claim 21 wherein the dividing wall is cylindrical at least in sections.

23. The absorption tower of claim 22 wherein the dividing wall is disposed in the column bottom in a concentric arrangement with a radial distance from an outer wall and divides the column bottom into a first cylindrical central region within the dividing wall and a second annular radially outer region outside the dividing wall.

24. The absorption tower of claim 22 wherein the dividing wall comprises:
a first, radially inner dividing wall that is disposed in the column bottom in a concentric arrangement with a radial distance from an outer wall of the column bottom; and
a second, radially outer dividing wall that is disposed in a concentric arrangement with a radial distance from the first, radially inner dividing wall and between the first, radially inner dividing wall and the outer wall.

25. The absorption tower of claim 24 wherein the second, radially outer dividing wall extends less far in an upward direction than the first, radially inner dividing wall.

26. The absorption tower of claim 24 wherein the dividing wall comprises a third dividing wall that is concentric with the second, radially outer dividing wall, between the second, radially outer dividing wall and the outer wall of the column bottom.

27. The absorption tower of claim 26 wherein the third dividing wall is shorter than the second, radially outer dividing wall.

28. The absorption tower of claim 21 wherein the dividing wall comprises mutually parallel dividing walls that divide the column bottom into one rectangular, radially inner region and two segment-shaped radially outer regions.

29. The absorption tower of claim 28 wherein the dividing wall comprises at least four mutually parallel dividing walls that divide the column bottom into one rectangular, radially inner region, two middle regions, and two segment-shaped radially outer regions.

30. The absorption tower of claim 21 comprising a cover above the dividing wall, wherein the cover is inclined at an angle relative to horizontal toward a middle of the column bottom, wherein the cover fully covers a shell space between the dividing wall and an outer wall of the column bottom.

31. The absorption tower of claim 21 comprising a cover disposed in the upper region at the dividing wall, the cover being inclined at an angle to horizontal toward a middle of the column bottom at least in sections.

32. The absorption tower of claim 31 wherein the dividing wall comprises a first dividing wall and a second dividing wall, wherein the cover is disposed on each of the first dividing wall and the second dividing wall in the upper region.

33. The absorption tower of claim 31 wherein the dividing wall comprises a first dividing wall and a second dividing wall, wherein the cover is sized and shaped such that the cover only partly covers a radially inner region of an annular gap between the first dividing wall that is radially further inward and the second dividing wall that is adjacent thereto and is radially further outward.

34. The absorption tower of claim 21 comprising:
a first conduit for nitric acid that extends from a first, radially inner region to draw off nitric acid therefrom; and
a second conduit for nitric acid that is separate from the first conduit and extends from a second, radially outer region to draw off nitric acid from the second, radially outer region.

35. A plant for producing nitric acid, the plant comprising an absorption tower that includes:
sieve trays disposed one on top of another and each spaced apart from one another;
an inlet for water in an upper region of the absorption tower;
an inlet for gaseous nitrogen oxides in a lower region of the absorption tower; and
a column bottom that is disposed in the lower region of the absorption tower beneath a lowermost sieve tray of the sieve trays, the column bottom being divided by a dividing wall into mutually separated regions, wherein the dividing wall is disposed with such a progression that the dividing wall divides the column bottom into a first, radially inner region and a second, radially outer region.

36. A process for producing nitric acid by the Ostwald process, the process comprising absorbing gaseous nitrogen oxides in water to produce nitric acid in an absorption tower, wherein the nitrogen oxides are introduced into the absorption tower in a lower region and water is introduced into the absorption tower in an upper region, wherein the nitric acid formed flows downward through sieve trays arranged one on top of another and each spaced apart from one another, wherein the nitrogen oxides flow upward from below through the absorption tower in countercurrent with an aqueous liquid, wherein in a column bottom of the absorption tower concentrated nitric acid accumulates, wherein a dividing wall in the column bottom creates mutually divided regions in which nitric acid of different concentration is collected, wherein by a cover above one of the mutually divided regions nitric acid that effluxes first from the sieve trays flows only into one of the mutually divided regions.

37. The process of claim 36 wherein concentrated nitric acid effluxing from the sieve trays is collected in a first, central region of the mutually divided regions of the column bottom, wherein only after this first, central region has filled completely does less concentrated nitric acid pass via overflow over the dividing wall into a second region of the mutually divided regions that is radially farther outward and is divided from the first, central region.

38. The process of claim 37 wherein after completely filling the second region less concentrated nitric acid passes via overflow over a second dividing wall into a third region of the mutually divided regions that is radially farther outward and is divided from the second region.

39. The process of claim 36 wherein positions of the dividing wall in the column bottom and of the cover above the mutually divided regions determines a ratio of volumes of more highly concentrated to less highly concentrated nitric acid that is produced.

40. The process of claim 36 wherein the process is performed in a plant that includes an absorption tower that comprises:
sieve trays disposed one on top of another and each spaced apart from one another;
an inlet for water in an upper region of the absorption tower;
an inlet for gaseous nitrogen oxides in a lower region of the absorption tower; and
a column bottom that is disposed in the lower region of the absorption tower beneath a lowermost sieve tray of the sieve trays, the column bottom being divided by a dividing wall into mutually separated regions, wherein the dividing wall is disposed with such a progression that the dividing wall divides the column bottom into a first, radially inner region and a second, radially outer region.
